(19) United States
(12) Patent Application Publication
(10) Pub. No.: US 2008/0085486 A1
(43) Pub. Date: Apr. 10, 2008

(54) Malleable Orthodontic Bracket

(75) Inventor: Paul Frederick Busch, Solana Beach, CA (US)

Correspondence Address: JONES DAY, 222 EAST 41ST ST, NEW YORK, NY, 10017, US

(73) Assignee: INJECTAMAX Corporation, Escondido, CA (US)

(21) Appl. No.: 11/857,252

(22) Filed: Sep. 18, 2007

Related U.S. Application Data
(60) Provisional application No. 60/828,143, filed on Oct. 4, 2006.

(51) Int. Cl. A61C 7/16

(52) U.S. Cl. 433/9; 433/24

(57) ABSTRACT

An orthodontic device includes a bracket that has a bracket pad with a first side that is intermittently etched. The bracket pad is malleable so that it can be configured to conform to a tooth. The bracket pad is composed of a single layer of material and is configured to be directly secured to the tooth on the first side A method of fitting an etched, malleable orthodontic device is also provided, and includes the steps of forming a mold of a patient's tooth, applying an etched, malleable bracket pad to the mold, and shaping the etched, malleable bracket pad to fit the mold, thereby forming a custom-fit bracket pad.

### CROSS-REFERENCE TO RELATED APPLICATION

This application claims the benefit of priority from U.S. Provisional Application No. 60/828,143, filed on Oct. 4, 2006. This prior application, including the entire written description and drawing figures, is hereby incorporated into the present application by reference.

### FIELD

This technology relates to orthodontic brackets for use as braces. In particular, the technology concerns a malleable, etched metal bracket pad that can be custom fit to a patient's tooth.

### BACKGROUND

Orthodontic braces are typically composed of a series of brackets 10 that are secured to the teeth 20 and an archwire 30 that is connected to each bracket 10 for adjusting the teeth 20. (See FIG. 1) A bracket 10 typically consists of a two-layer bracket/pad structure (see FIG. 1a), a stainless steel sheet stock 12 and a wire mesh layer 14 secured with numerous spot welds to the stainless steel sheet layer 12. A bracket also has a connecting portion that secures the archwire to the bracket. Brackets are typically adhered directly to the first five teeth on each side of the center of the mouth with the mesh layer facing the tooth, but the brackets must be particularly well secured to the molars because these larger teeth are used as a foundation to pull the other teeth around. To provide a secure connection, orthodontists have traditionally welded the brackets 10 for the molars onto metal bands 40 that are placed around and adhered to the molars themselves. The brackets 10 that are adhered to the molars are called ‘buccal tubes’ 50 and are often bigger and may have additional wire slots. These buccal tubes 50 are used as anchors for the archwire and additional appliances 30. After securing all the brackets 10 to the teeth 20, the archwire 30 is connected to each bracket 10 and adjusted by the orthodontist to promote proper alignment of the teeth.

To accommodate all the different sizes of molars, the industry has thirty-two basic sizes of “seamless welded” bands, each available with three expansion alternatives. This totals one-hundred twenty-eight different sizes of bands in the marketplace that an orthodontist may select from and in order to accommodate the various sizes of people's teeth. Most orthodontists rely on the manufacturer to supply the needed size of bands to fit the patient's teeth, and ship them overnight. The other alternative is for the orthodontist to stock all sizes of bands for immediate use themselves.

The process of putting the band around the molar can be painful and difficult. Gluing the bracket directly to the molar would be preferable; however, achieving a bond strength that is sufficient to anchor the braces on the molars is a problem. There is also a problem with fitting a standard bracket directly to the molars because of the various shapes and sizes of the teeth, where traditionally this has required an inventory of one-hundred twenty-eight sizes of bands to fit.

A malleable, etched orthodontic bracket and a method for fitting the bracket is described and claimed.

### BRIEF DESCRIPTION OF THE DRAWING FIGURES

FIG. 1 is a side view of a prior art orthodontic braces system attached to an upper and lower set of teeth.

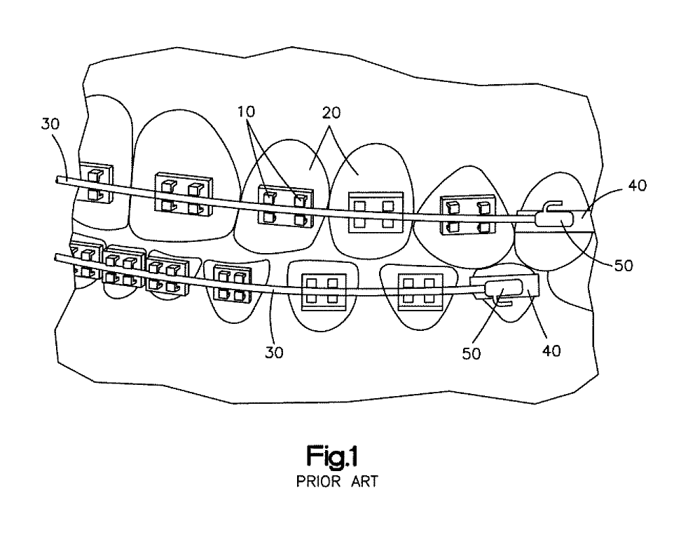

FIG. 1 a is perspective view of a prior art orthodontic bracket.

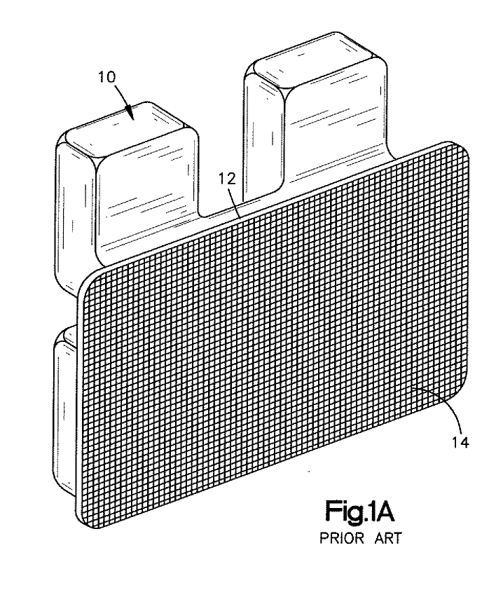

FIG. 2 is a perspective view of an example etched bracket pad.

FIG. 3 is a cross-sectional view of an example etched bracket pad.

FIG. 4 is diagram of an example two-side etched bracket pad.

FIG. 5 is diagram of a second example two-side etched bracket pad.

FIG. 6 is diagram of a third example two-side etched bracket pad.

FIG. 7 is a flow chart illustrating a method of custom fitting an etched bracket pad.

### DETAILED DESCRIPTION

The technology described herein provides for a single-layer bracket pad that is etched so that it is thinner in several areas and therefore malleable. The technology described herein allows a dentist to customize a standard etched bracket to fit a mold of a patient's tooth. While the prior art required an inventory of many different sizes of bands to fit patients' teeth, the technology described herein allows a dentist to only keep one or very few sizes of brackets with malleable pads, which can then be customized to fit the patient's teeth. The single layer design also eliminates the mesh layer of prior art brackets. The mesh layer of the prior art brackets serves as a truss structure to make the two-layer bracket stiff and unmalleable.

The etchings in the malleable brackets described herein also provide a surface on which adhesive can attach and be securely held so there is no need for the mesh backing used in the prior art. The example brackets are etched with an undercut so that adhesive can fill into and be secured in the undercut. The undercut feature of the etchings provides a greater bond strength compared to the prior art mesh, and is sufficient to hold the bracket to a molar even when the bracket is used as an anchor for the archwire. Tests of the etched bracket have shown approximately a 50% increase in bond strength over the traditional two-layer mesh design. This is achieved without increasing the surface area of the etched bracket pad beyond that of prior art two-layer bracket pads.

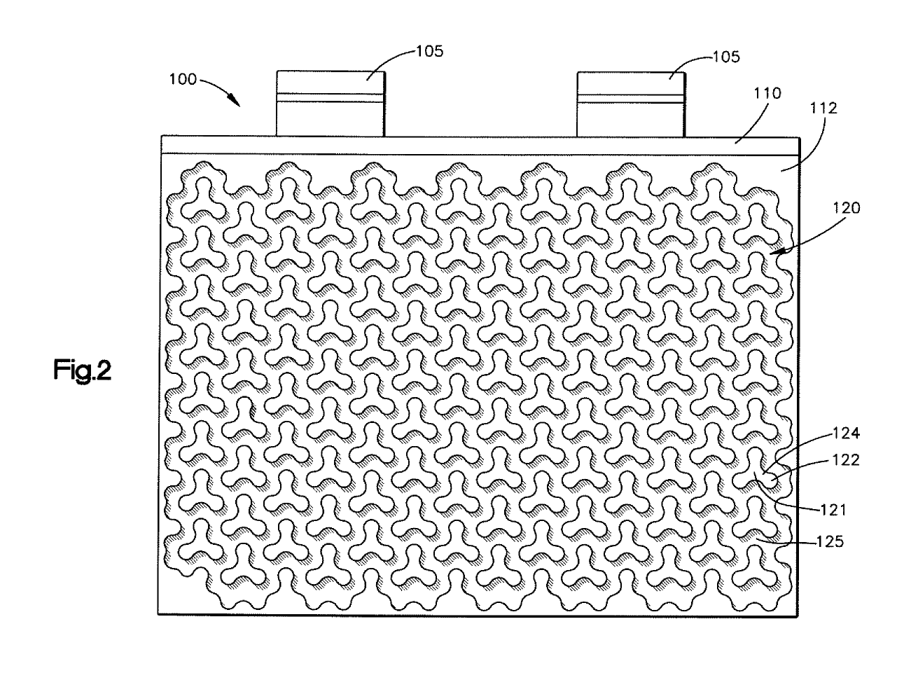

FIG. 2 shows an example etched bracket 100. The etched bracket 100 includes a bracket portion 105 that is brazed onto the outward facing side of the bracket pad 110. The bracket portion 105 is configured to hold a standard sized archwire. The side of the bracket pad 110 that will face the tooth, i.e. the tooth-facing side 112, is etched in an example pattern 120. This example repeating propeller shaped pattern 120 has been shown to provide good malleability and strength.

In this example, the pattern consists of a repeating series of three-bladed propeller shapes 121. The propellers 121 are level with the unetched surface of the tooth-facing side 112 of the bracket pad 110. Etched grooves 125 surround and define the propellers 121. Each blade of the three-bladed propellers has a slightly larger terminal end 122 than central connecting end 124. The etched grooves 125 define the propeller shapes 121 and separate the edges of the propellers 121 by a distance that is constant, within manufacturing tolerances. This is just one example pattern and other patterns may also be etched on the tooth-facing surface and be consistent with the disclosed technology. For example, repeating circular, elliptical, rectangular, diamond, and triangle patterns also work, among other shapes and patterns. The pattern may be regularly repeating or irregular, and may consist of a mixture of different shapes and patterns.

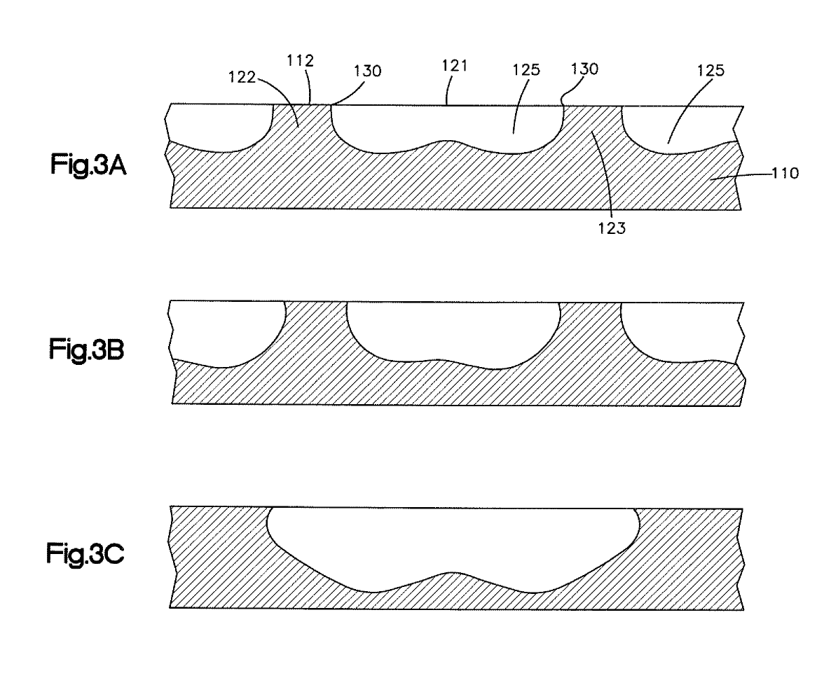

FIG. 3 shows a cross-sectional view of the bracket pad 110. The etched grooves 125 that are disposed between the cross-sections of two propeller blades 122, 123 are prominently shown, and the end of a propeller blade 121 can be seen in the background. The grooves 125 have a slight overhanging portion 130 near the top of the unetched surface 112. This is what is referred to as an undercut. When filled with adhesive, the undercut 130 provides a retaining surface to hold the adhesive inside the groove 125, thereby preventing transverse forces from causing the adhesive bond to break away from the tooth. This encourages a failure mode of sheer instead of peel.

Processes to make undercut etchings have been known by those of skill in the art, but were considered undesirable in general. Example methods of creating an undercut etching include, changing the etching reagent during the etching process or changing the reaction temperature. The example etching of FIG. 3 was performed by Interplex Etch Logic LLC of Attleboro, Mass.

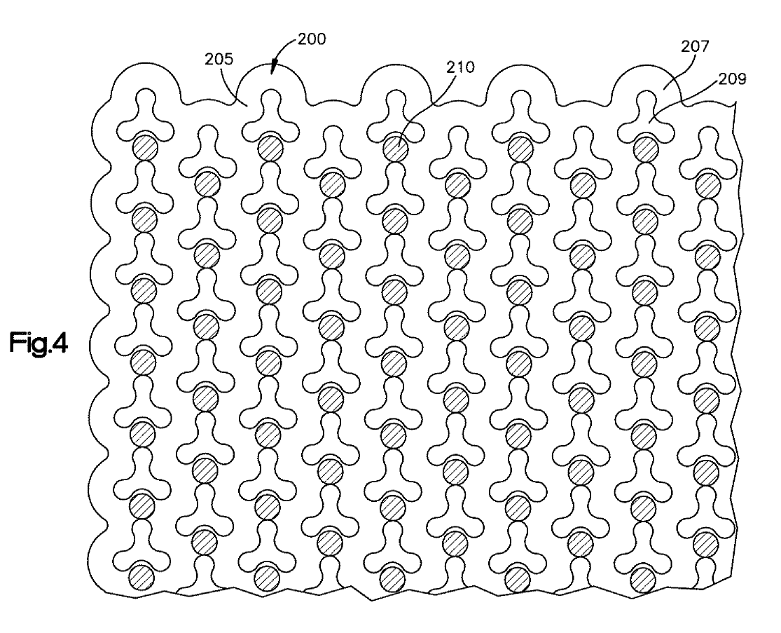

FIG. 4 is a diagram of an example etched bracket pad design 200 that has a propeller pattern on the tooth-facing side 205, including etched grooves 207 that define propellers 209. As in the example shown in FIGS. 2 and 3, the propellers are each separated on each side by the same distance. The dark circles interspersed between the propellers represent generally cylindrical etchings 210 on the opposite side. These cylindrical holes 210 in the opposite side improve the malleability of the bracket. The holes 210 may or may not be etched all the way through to the tooth-facing side. The holes 210 are not necessarily cylindrical or circular, but may be elliptical, rectangular, diamond, and triangle shaped, among other shapes. The pattern of the holes 210 may be regularly repeating or irregular, and may consist of a mixture of different shapes and patterns.

If the cylindrical holes 210 are etched all the way through so that the holes 210 open into the grooves 207 on the tooth-facing side, this provides another benefit. Most known adhesives that are used to attach brackets to teeth are photosensitive and cure faster when exposed to light. The holes 210 operate as a light window to speed the curing process of the adhesive. Furthermore, as the adhesive fills the grooves 207 on the tooth facing side, some adhesive may also seep into the cylindrical holes 210. The cylindrical holes may have a collar or an irregular surface at the opening to the groove 207 that can provide the adhesive with another anchoring surface that functions to hold the adhesive in the bracket, similar to the overhang of the groove as described above.

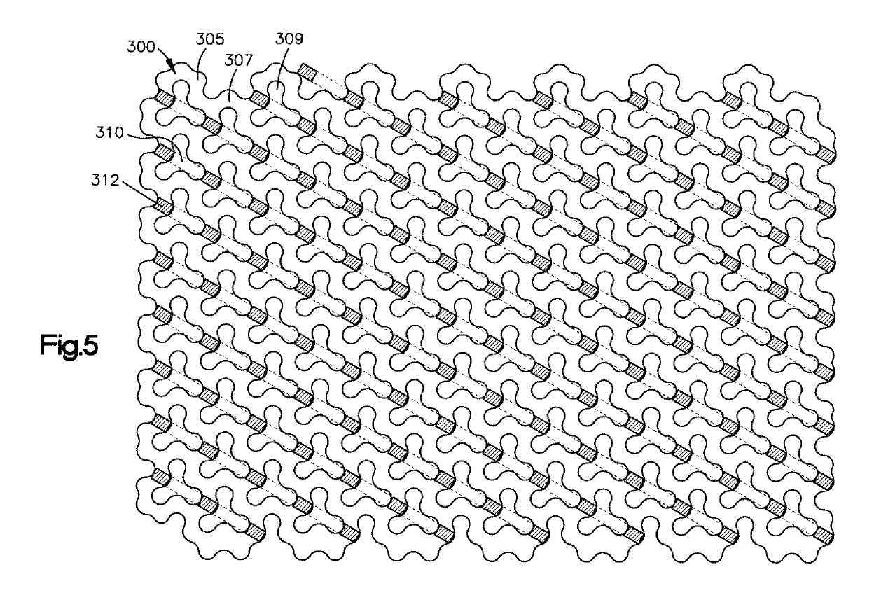

FIG. 5 is a diagram of an example etched bracket pad design 300 that has a propeller pattern on the tooth-facing side 305, including etched grooves 307 that define the propellers 309. The lines running diagonally across the design indicate grooves 310 that are etched on the opposite side of the bracket. The dark areas on the lines indicate through holes 312 where the grooves 310 on the opposite side open into the grooves 307 on the tooth-facing side. Compared to the single-sided etched example, this design further enhances the malleability of the bracket and also enhances the cure and the strength of the connection between the bracket and tooth, as described above.

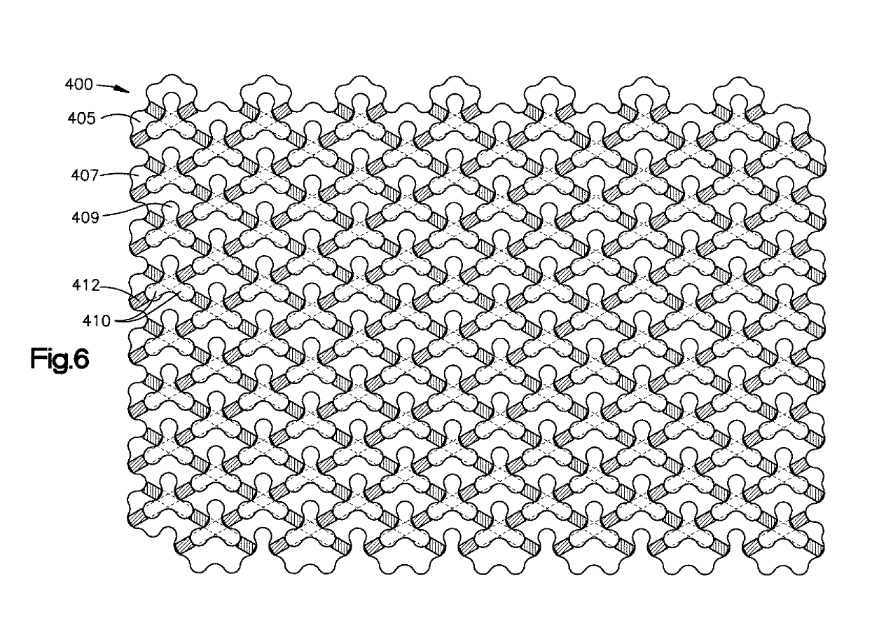

FIG. 6 is a diagram of an example bracket pad design 400 that has a propeller pattern on the tooth-facing side 405, including etched grooves 407 that define propellers 409. The lines running in two diagonal directions across the design indicate grooves 410 that are etched on the opposite side of the bracket. The dark areas on the lines indicate through holes 412 where the grooves 410 on the opposite side open into the grooves 407 on the tooth-facing side. Compared to the single-sided etched example, this design further enhances the malleability of the bracket and also enhances the cure and the strength of the connection between the bracket and tooth, as described above.

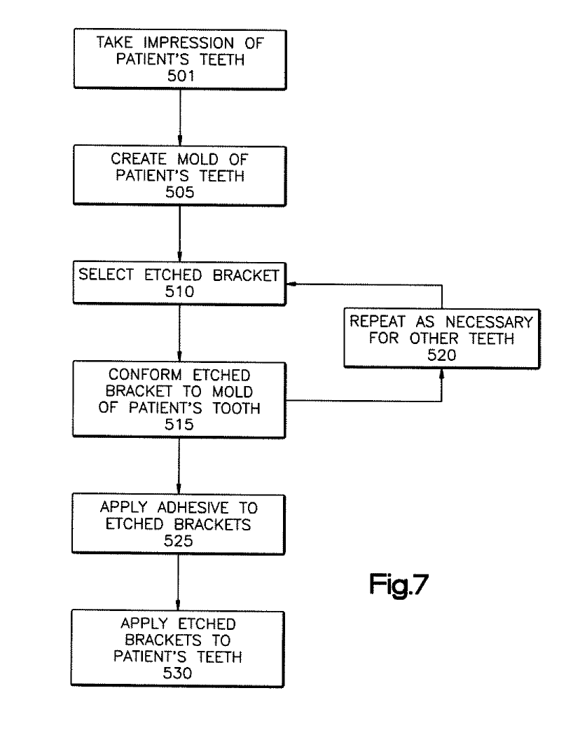

FIG. 7 is a flow chart showing an example method of fitting and applying an etched bracket to a patient's teeth. First, an impression of the patient's teeth is made 501. While the impression of only one tooth could be done at this time, it is more efficient to take an impression of all the teeth that will need an etched, malleable bracket. Next, a mold is created 505 from the impression of the patient's teeth, that was created in the first step 501. Typically, this mold is created out of a plaster or stone material. It is not necessary to create an impression and mold of the entire tooth, but only the outside-facing surface of the tooth where the bracket will be positioned.

The next step is to select a bracket previously attached to an etched pad 510. There may be only one etched bracket pad size and shape to select from, or there may be a few sizes and shapes to select from, i.e. less than ten, but the number of different bracket pads will be much fewer than the one-hundred and twenty-eight standard sizes of bands that the prior art requires. The orthodontist should be able to have a stock of the brackets on hand and ready to be fitted to any patient. The next step is to form the pad to match the mold of the patient's teeth 515. This is done by placing the selected bracket on the mold and tapping the pad with a small hammer to conform the etched pad to the shape of the mold, thereby achieving a custom configured bracket to fit the contours of the patients tooth. Other methods for conforming appliances to patients' teeth as known by those of skill in the art may also be used. Steps 510 and 515 are repeated as necessary until all the brackets for the teeth that need custom fit brackets are customized—for example, all the molars.

The adhesive is then applied to the etched bracket pad 525, and the etched brackets are placed on and secured to the patient's teeth 530. The curing process may be accelerated by shining a high-intensity or other light on the etched bracket. The curing process will be faster with example brackets that have through holes etched in the bracket pad as described in the examples shown in FIGS. 3-5.

The brackets with etched pads may be used in conjunction with prior art brackets and archwires to form a full set of braces. The etched brackets may be used on the molars and particularly for the molars that are used to anchor the braces with buccal tubes and that traditionally would have required bands. Traditional brackets may be used for the first five teeth on each side that typically do not require a custom fit. A standard archwire may be used to connect each bracket, including the etched brackets and the prior art brackets.

It is also possible to have a fully customized set of braces, where each bracket is an etched bracket and is configured to fit on a mold of each of the patient's teeth.

While various features of the claimed examples are presented above, it should be understood that the features may be used singly or in any combination thereof. The examples described herein are exemplary. Therefore, the claimed examples are not to be limited to only the specific examples depicted herein. Further, it should be understood that variations and modifications of the above described technology may occur to those skilled in the art to which this disclosure pertains. The disclosure may enable those skilled in the art to make and use examples having alternative elements that likewise correspond to the elements recited in the claims.

What is claimed is:

1. An orthodontic device comprising:
a bracket, the bracket having a bracket pad with a first side that is intermittently etched to form etched grooves;
the bracket pad being malleable so that it can be configured to conform to a tooth; and
the bracket pad being configured to be directly secured to the tooth on the first side.

2. The orthodontic device of claim 1, wherein the bracket further includes a structure for retaining an archwire.

3. The orthodontic device of claim 2, further comprising the archwire coupled to the structure for retaining the archwire.

4. The orthodontic device of claim 1, wherein the etched grooves are undercut so that an outer surface of the first side of the bracket pad overhangs a portion of the etched grooves.

5. The orthodontic device of claim 4, further comprising an adhesive coupled to the bracket, wherein the adhesive fills the spaces defined by the etched grooves in the first side.

6. The orthodontic device of claim 1, wherein the etched grooves in the etched first side of the bracket pad are in a repeating pattern.

7. The orthodontic device of claim 6, wherein the etched grooves have surface openings that are of an approximately constant distance from one side to the other throughout the entire etched pattern.

8. The orthodontic device of claim 7, wherein unetched portions formed by the etched grooves are each in the shape of a three-bladed propeller.

9. The orthodontic device of claim 1, wherein a second side of the bracket pad is also etched.

10. The orthodontic device of claim 9, wherein grooves are etched on the second side of the bracket pad, and the etched grooves are elliptical or circular holes and are arranged so that the holes on the second side overlap with the etched grooves on the first side.

11. The orthodontic device of claim 10, wherein the holes on the second side of the bracket pad open into the etched grooves on the first side.

12. The orthodontic device of claim 10, wherein the etched grooves on the second side of the bracket pad include a first set of substantially parallel grooves.

13. The orthodontic device of claim 12, wherein the etched grooves on the second side of the bracket pad open into the etched grooves on the first side of the bracket pad, where the grooves on the second side intersect with the etched grooves on the first side.

14. The orthodontic device of claim 10, further comprising a second set of parallel grooves on the second side of the bracket pad that run in a different direction than the first set of grooves.

15. The orthodontic device of claim 8, wherein the etchings on the second side of the bracket pad include a first set of substantially parallel grooves and a second set of substantially parallel grooves that run in a different direction than the first set of substantially parallel grooves;
wherein the first and second set of grooves on the second side of the bracket pad open into the etched grooves on the first side of the bracket pad where the grooves of the first and second sides intersect.

16. The orthodontic device of claim 1, wherein the bracket pad is a single-layer pad.

17. Orthodontic braces comprising:
a set of brackets including the orthodontic device of claim 1;
an archwire;
the archwire being secured to each bracket in the set of brackets.

18. The orthodontic braces of claim 17, wherein the orthodontic devices are configured to be secured to each of a patient's molars.

19. A method of fitting an etched, malleable orthodontic device, the steps of which comprise:
forming a mold of a patient's tooth;
applying an etched, malleable bracket pad to the mold;
shaping the etched, malleable bracket pad to fit the mold, thereby forming a custom-fit bracket pad.

20. The method of claim 19, further comprising applying an adhesive to the custom-fit bracket pad and applying the custom-fit bracket pad to the patient's tooth.

21. The method of claim 20, further comprising coupling an archwire to the custom-fit bracket pad and connecting the custom-shaped bracket pad to a set of braces.

22. An etching pattern for application to an orthodontic bracket comprising a plurality of etched grooves and raised portions arranged on a surface of an orthodontic bracket;
said raised portions including an undercut adjacent to the etched grooves.

23. The etching pattern of claim 22, wherein the etched grooves are formed in a regularly repeating or an irregular pattern.

24. The etching pattern of claim 23, wherein the pattern is propeller-shaped, circular, elliptical, rectangular, diamond-shaped, triangular, or a mixture thereof.

25. The etching pattern of claim 22, further comprising a plurality of holes extending at least partially through the opposite surface of the bracket.
